(19) United States
(12) Patent Application Publication
(10) Pub. No.: US 2023/0382707 A1
(43) Pub. Date: Nov. 30, 2023

(54) A BEVERAGE DISPENSING APPARATUS

(71) Applicant: HODGES & DRAKE DESIGN LTD, Leicester, Leicestershire (GB)

(72) Inventors: Tim WHATELEY, Leicester (GB); Craig JONES, Coventry (GB)

(21) Appl. No.: 18/250,862

(22) PCT Filed: Nov. 1, 2021
(86) PCT No.: PCT/EP2021/080240

§ 371 Date: Apr. 27, 2023

(30) Foreign Application Priority Data
Nov. 2, 2020 (GB) 2017357.1
Dec. 16, 2020 (GB) 2019898.2

(51) Int. Cl. B67D 1/00; B67D 1/10; B67D 1/08

(52) U.S. Cl. CPC B67D 1/0037; B67D 1/108; B67D 1/0888; B67D 2001/082; B67D 2210/00062; B67D 2210/00031

(57) ABSTRACT

A beverage dispense fount apparatus (1) suitable for dispensing beverages such as beers or ciders with the addition of additives such as sweeteners and flavourings. The apparatus (1) comprises a beverage inlet (2) connectable to a beverage supply; a beverage outlet (3) configured to dispense beverage into a beverage container; a supply line formed between the beverage inlet (2) and the beverage outlet (3); one or more additive containers (13), each removably mounted within the apparatus and each in fluid connection with a separate additive dispensing line (14); a dispensing pump (15) for each additive container (13) to dispense additive through the additive dispensing lines (14); and a controller for controlling dispensing of additives from the fount apparatus (1). The apparatus (1) may comprise a video screen (9) for interactive video display to customers and a touch screen (10) for controlling operation of the apparatus (1). A video screen (9) may display videos determined on the basis of the beverage dispensed. The apparatus (1) may comprise data storage and communication means that allow information on customers and beverages dispensed to be collected, remotely stored, and analysed.

### FIELD OF THE INVENTION

The present invention relates to the dispensing of beverages in hospitality venues such as public houses, restaurants, and cafes. The present invention particularly relates to beverage dispense founts, such as those that might dispense beer, cider, alcoholic seltzer, non-alcoholic or other similar beverages at a bar.

### BACKGROUND OF THE INVENTION

In hospitality venues, such as public houses, bars and restaurants, beverages are often dispensed to a user at a beverage dispense fount mounted on a counter or bar, such dispense founts include traditional beer pumps as well as more modern button or switch operated beverage dispensers. In modern establishments a huge variety of beverages are dispensed from beverage dispensers including, but not limited to, beers, ciders, alcoholic seltzers, soft drinks, pre-mixed drinks, wines, and water. Different brands of beverages will often have different distinctively decorated beverage dispensers in order to attract a customer's attention and to entice a customer to order the beverage dispensed from that dispenser. This is particularly true of beer, cider and wine dispensers in bars and clubs, where a customer will approach the bar at which the dispense fount(s) are located in order to order a beverage.

Generally, dispense founts are used to serve beverages from large containers such as kegs and barrels or with certain non-alcoholic beverage systems, mains water and pumped syrups are supplied. Carbon dioxide or nitrogen gas can be added to a beverage or used for pressurising the systems and preservation of the beverages.

An advantage that dispense founts offer is that when the beverage is stored in large containers, such as kegs or barrels, the beverage can be transported and stored in one place and when the container is emptied, it can be returned to the supplier to be reused. Due to the bulk handling nature of this solution, beverage costs are lower than beverages stored in bottles. Similarly, syrups stored in bulk bag-in-box containers and added via pump systems to carbonated mains water, provide beverages at a lower cost than bottled beverages, thereby returning higher profits to the retailer.

A disadvantage concerning dispense founts is that due to the bulky nature of the storage means for the beverages and syrups, as well as the carbon dioxide and nitrogen gases used, and other equipment, generally these items are located away from the bar to free up space for storage of other bar items, such as glasses, etc. When there are several draught products on offer, more storage space is required for the bulk beverage containers and additional equipment.

At a bar there will normally be a range of draught beverages available, however the number of draught products is limited by the space available to locate dispense founts and to advertise availability of the beverage. Typically each different draught beverage will have a different dispense fount, for example a bar having a range of draught beers will usually have a separate beer tap for each draught beer.

Beverages are often brewed or mixed with additives, such as botanicals, flavours, sweeteners and CBD oils. Generally, these are supplied to a retailer in pre-mixed forms. However, some retailers will mix beverages with additives and there are some existing dispensing solutions that act to mix beverages with additives.

In addition, beverage containers, such as kegs, that are filled with beverages brewed or mixed with additives, such as botanicals, flavours, sweeteners and CBD oils, are often difficult to clean due to contamination of the additives used. This can make it difficult to re-use a container with other beverages. For this reason it would be advantageous to mix drinks after dispensing from a container.

In order to maximise sales of a beverage it is important that dispense founts are attractive to consumers. Therefore, attractive visuals and/or advertising is often displayed on or adjacent to a dispense fount.

### SUMMARY OF THE INVENTION

The present invention provides a beverage dispense fount apparatus comprising:
a beverage inlet connectable to a beverage supply;
a beverage outlet configured to dispense beverage into a beverage container;
a supply line formed between the beverage inlet and the beverage outlet;
at least one additive container, removably mounted within the apparatus and each in fluid connection with an additive dispensing line;
a dispensing pump for the or each additive container to dispense additive through the or each additive dispensing line; and
a controller for controlling dispensing of additives from the fount apparatus.

The present invention is advantageous in that it provides a simple and convenient dispensing means for mixing draught beverages with additives. By removably mounting the additive containers in the dispense fount apparatus they can be stored easily and can be swapped over in a simple manner at the dispense fount apparatus itself. In this manner the present invention provides a means to add additives to a draught beverage at the point of dispense in a very compact and convenient format.

The dispense fount apparatus of the present invention is suitable for use with any draught beverage to which additives can be added. This includes, but is not limited to, beers, ciders, alcoholic seltzers, wines, and soft drinks. Similarly, the dispense fount apparatus of the present invention may utilise any liquid additive suitable for adding to a draught beverage. This includes, but is not limited to, sweeteners, flavourings, colourings, CBD extracts, botanicals, and caffeine. Generally, the additives will be suitable for dispensing in small volumes from an additive container into a relatively larger volume of draught beverage. By adding one or more additives to a draught beverage it is possible to change the flavour, colour and other characteristics of the draught beverage and provide a wider menu of beverage options. In this manner, more beverage options can be provided without requiring additional bulk containers such as kegs and barrels and the necessary system equipment. The present invention also provides means to quickly change additives that prove unpopular.

Embodiments of the invention may comprise at least two additive containers, each removably mounted within the apparatus and each in fluid connection with a separate additive dispensing line. This may be advantageous as it can allow two or more different additives to be dispensed by the same apparatus. Providing separate additive dispensing lines for each additive container is beneficial as it prevents cross-contamination of the additives.

The beverage dispense fount apparatus of the present invention may further comprise a mechanical actuating member operable by a user to dispense beverage from the beverage outlet. Suitable mechanical actuating members, include pull handles, twist taps, flip handles, resiliently biased taps, buttons and any other mechanical actuating member that is utilised on known beverage dispense founts. In simple embodiments of the invention the mechanical actuator may comprise a resiliently biased lever formed in the same manner as draught beer dispensing founts.

The beverage dispense fount apparatus may comprise one or more dispensing motors, each associated with an additive container for driving the dispensing pump associated with said additive container. The dispensing motors may be any suitable motor for driving a dispensing pump. Advantageously, the dispensing motors will be stepper motors capable of precise control of dispensing pumps.

The dispensing pumps may be any pump suitable for dispensing small amounts of liquid from the additive containers. In embodiments of the invention the dispensing pumps are peristaltic pumps. For example, peristaltic pumps suitable for use in the present invention are disclosed in GB2535595. If the invention comprises peristaltic pumps they may each engage with a dispensing motor and be retained in position in the apparatus by means of one or more releasable clips. In such embodiments the pumps may consist of a pump module containing a pump housing, rotor, slip-ring and tubing, wherein the tubing forms part of an additive dispensing line. Such pumps may be replaced when they wear out, after approximately 10,000 or more dispenses or when the additive type is changed to prevent cross-contamination. Peristaltic pumps in accordance with GB2535595 can accurately and repeatedly dispense small volumes of liquid into a container of around 0.15% volume of the liquid within a container. For example, a volume of 0.852 ml can be dispensed into a container with 568 ml (1 pint) of liquid. This facilitates the use of highly concentrated additives stored in relatively small volume additive containers, thereby reducing the need to regularly change the or each additive container and enabling the or each additive container due to their small size to be conveniently located at the point of dispense.

The or each additive dispensing line may engage with the or each additive container by means of a quick-change connecter, such as a luer fitting. This can enable quick removal and replacement of an additive container. In embodiments of the invention a luer fitting can be combined with a screw connection to form a robust and reliable removable connection. The or each additive container may be formed to have a threaded connecting portion at an upper end and a luer fitting or other quick change connector formed centrally within the threaded connecting portion. In particular, a luer fitting may be centrally mounted within a threaded connection such that screwing an additive container into position will push a luer fitting into fluid engagement. Similarly, if the or each pump is removable then there may be a quick change connector, such as a luer fitting, between an outlet of the pump and a dispensing line integrally routed in the dispense fount apparatus to allow the pump to be removed and replaced in a quick and easy manner.

A connection between an additive container and the dispense fount apparatus may be pivotable to allow easy insertion and removal of the additive containers when required. That is, the dispense fount apparatus may comprise a pivoting connector that can be pivoted between a first position in which the additive container is stored in an orientation suitable for dispensing additives and a second position in which the additive container can be easily inserted into and removed from the dispense fount apparatus. The first position may be a substantially vertical position and the second position may be a tilted position wherein the additive container is tilted away from vertical.

As an alternative to having the or each additive container removable separate from the dispensing pumps, each pumps could be integrally formed with an additive container to form a replaceable cartridge. For example, the or each additive container and associated dispensing pump could form a removable and replaceable cartridge in the manner described in PCT/GB2015/033777.

A beverage dispense fount apparatus according to the present invention may have any number of additive containers in accordance with claim 1. The dispense fount apparatus may comprise one, two, three, four, or more additive containers. In embodiments of the invention the dispense fount apparatus may have exactly three additive containers.

The additive containers of the present invention may be arranged within the dispense fount apparatus in any suitable manner. In embodiments of the invention the or each additive container may be held in a substantially vertical position and may be aligned vertically above one another. This can provide a compact construction enabling the minimisation of space at the point of dispense where space is at a premium.

A dispense fount apparatus according to the present invention may comprise a housing through which the supply line runs and within which the or each additive container and the or each dispensing pump are housed, wherein the housing is openable to allow removal and replacement of the or each additive container. A housing may also be openable to allow access to any other component of the dispense fount apparatus to which access may be required. A housing may have one, two, or more, openable sections. An opening may be formed on a dispensing side of the apparatus to allow easy access to, and replacement of, the additive containers.

In embodiments of the invention one or more dispensing fluid lines may be in fluid connection with the supply line, optionally via a suitable valved connection. This will allow additive to be dispensed from an additive container directly into the supply line and to be mixed with the beverage in the supply line.

In addition or as an alternative one or more dispensing lines may extend through the dispense fount apparatus to an additive outlet positioned adjacent the beverage outlet, such that the additives are dispensed from the additive outlets adjacent the beverage dispensed from the beverage outlet and are subsequently mixed. Subsequent mixing may be achieved in a beverage container into which the beverage and additives are dispensed. Alternatively or additionally the dispense fount apparatus may further comprise a nozzle, wherein the nozzle is mounted around the beverage outlet and the or each additive outlets and effects mixing of the additives and the beverage when they are dispensed.

In embodiments of the present invention a flow sensor is located in the supply line to detect dispensing of a beverage through the supply line. This can be advantageous as a flow sensor can be used to detect flow rates during dispensing of the beverage through the supply line. This information can be used to control the dispensing of additive during the flow of the beverage. This allows the volume of dispensed additive to be controlled on the basis of the beverage flow rate, which can provide for more accurate dosing of the beverage with any additive. In embodiments of the invention the operation of the or each dispensing pump to dispense additives from the additive containers is controlled by a flow sensor in the supply line on the basis of a desired composition of the beverage dispensed.

The present invention may comprise a video screen on a customer facing side of the apparatus. A customer facing video screen may be controlled to provide suitable information, images, videos, and communications to a customer. For example, it may communicate to a consumer a menu of the various beverages available based on additions of the additives to the beverage to which the display fount apparatus is connected. A menu can be programmed to be dynamic and change to suit times of the day, the week, special events or even change in seasons to suit consumer tastes. A video screen may also display a beverage selected to be dispensed when a customer makes an order. In embodiments of the invention a video screen may be controlled to show a video on the video screen when a beverage is dispensed; the video being selected on the basis of the specific combination of beverage and additives that is being dispensed.

The dispense fount apparatus of the present invention may further comprise a touch screen on a dispensing side of the apparatus for selecting the beverage and additives to be dispensed. Such a touch screen can be formed in any manner apparent to a person skilled in the art. Alternative controls and dispensing means may be provided in addition to, or as an alternative to, a touch screen. In embodiments of the invention a video screen may be provided on the dispensing side of the display fount apparatus in addition to, or as part of, a touch screen. A video screen may be used for displaying the chosen beverage, beverage and additive container volumes, notification warnings, prices, and any other suitable information. A touch screen may be used for dispensing a chosen beverage, manual input of recipes, or any other suitable operating instruction.

A beverage dispense fount apparatus according to the present invention may further comprise a data storage means for storing information on the beverage and additives dispensed from the apparatus. Such data may be stored alongside customer information, which may be manually input and/or collected by a presence sensing means in the manner discussed below.

In embodiments of the invention the beverage dispense fount apparatus may comprise presence sensing means for detecting information relating to a customer ordering a beverage. Any suitable presence sensing means can be utilised. In embodiments of the invention the presence sensing means may comprise an image sensor for detecting information relating to the customer such as age, gender, or other detectable visual characteristics of the customer. However, it may be generally advantageous that a presence sensing means comprises means for detecting a customer's mobile device and collecting demographic information therefrom. For example, a presence sensing means may comprise a presence sensor that continuously collects mobile carrier signal information in the proximity of the dispense fount apparatus and compares it with customer information in a mobile phone operator's database in order to identify individual mobile devices from that database. This can allow the collection of anonymised or pseudo-anonymised analytic information such as customer age range, gender, ethnicity, as well as walk maps and product engagement of customers.

The apparatus of the present invention may further comprise a data connection for sharing collected and stored information, for updating software and firmware, and for any other suitable reason. The data connection may be wired or wireless and may allow the apparatus to be in communication with a remote server, analytics engine, or control module. In embodiments of the invention the apparatus further comprises a cellular router to allow communication with a remote server.

In embodiments of the invention the or each additive dispensing line may be in fluid connection with the supply line immediately prior to the beverage outlet by means of an outlet port. In such embodiments additives are added to the beverage immediately prior to the beverage outlet and can thereby be evenly dispersed in the beverage as the beverage is dispensed. In particular, the additives are mixed with the beverage in the supply line immediately before the beverage outlet and as the beverage is dispensed from the beverage outlet, rather than mixing in a beverage container. In such embodiments, in order to ensure that no additive and/or beverage is retained in the beverage outlet after a beverage has been dispensed it may be advantageous that the beverage dispense fount further comprises an air pump that is in fluid communication with an air port formed adjacent the additive outlet ports and immediately prior to the beverage outlet such that air can be pumped into the supply line immediately prior to the beverage outlet.

Providing an air pump in fluid communication with an air port formed immediately prior to the beverage outlet is advantageous as it can be utilised to flush the beverage outlet in between uses. In particular, after a beverage has been dispensed the air pump can be operated to provide a blast of air through the air port into the beverage outlet to clear any beverage and/or additive remaining in the beverage outlet. A beverage dispense fount formed in this manner can be controlled to provide an air blast through the beverage outlet immediately after a beverage has been dispensed or at any other appropriate time.

Alternatively or in addition to an air pump in fluid communication with an air port, a vent may be provided in the supply line immediately prior to the beverage outlet to ensure that additive and/or beverages are not retained in the beverage outlet after dispensing. Providing a vent in the beverage outlet is advantageous as it prevents liquids being retained in the beverage under surface tension, instead ensuring that liquids fall straight out of the beverage outlet into a beverage container. If a vent is provided in a beverage outlet it may be preferable that an outlet of the vent is provided such that any fluid exiting the vent is directed to a beverage container. This can be achieved, for example, by providing a vent tubing that is open at each end and extends from the beverage outlet generally downwardly to an appropriate position above a beverage container.

A second invention provides a beverage dispense fount apparatus comprising:
a beverage outlet configured to dispense beverage into a beverage container;
a supply line connected with the beverage outlet;
at least one additive dispensing line in fluid connection with the supply line immediately prior to the beverage outlet by means of an additive outlet port; and
an air outlet port formed in the supply line immediately prior to the beverage outlet.

The second invention is advantageous in that it provides a beverage fount construction in which additives may be added to a beverage in a supply line immediately prior to the beverage outlet. This facilitates even dispersion of an additive in a beverage. In particular, the additives are mixed with the beverage in the supply line immediately before the beverage outlet and as the beverage is dispensed from the beverage outlet, rather than mixing in a beverage container. In order to ensure that no additive and/or beverage is retained in the beverage outlet after a beverage has been dispensed the apparatus further comprises an air outlet port formed in the supply line immediately prior to the beverage outlet.

In embodiments of the second invention the beverage dispense fount further comprises an air pump in fluid connection with the air outlet port via an air supply line, such that air can be pumped from the air pump into the beverage supply line via the air supply line. Providing an air pump in fluid communication with an air port formed immediately prior to the beverage outlet is advantageous as it can be utilised to flush the beverage outlet in between uses. In particular, after a beverage has been dispensed the air pump can be operated to provide a blast of air through the air port into the beverage outlet to clear any beverage and/or additive remaining in the beverage outlet. A beverage dispense fount formed in this manner can be controlled to provide an air blast through the beverage outlet immediately after a beverage has been dispensed or at any other appropriate time.

In alternative embodiments of the second invention the beverage dispense fount further comprises air vent tubing that is attached at an inner end to the air outlet port and is open at an outer end. Providing air vent tubing fluidly connected to the supply line immediately prior to the beverage outlet is advantageous as it prevents liquids being retained in the beverage under surface tension, instead ensuring that liquids fall straight out of the beverage outlet into a beverage container. If a vent is provided in a beverage outlet it may be preferable that an outlet of the vent is provided such that any fluid exiting the vent is directed to a beverage container. This can be achieved, for example, by providing a vent tubing that is open at each end and extends from the beverage outlet generally downwardly to an appropriate position above a beverage container.

The second invention of the present application may include any of the features of the first invention discussed above. Unless otherwise indicated by context features of the first invention may be included in the second invention in isolation or in combination with any of the other features in any manner that would be understood by the person skilled in the art.

Further features and advantages of the inventions will be apparent from the embodiment of the invention shown in the drawings and described below.

### DRAWINGS

FIG. 1 is first perspective view of an embodiment of a beverage dispense fount according to the present invention;

FIG. 2 shows the embodiment of FIG. 1 from the first perspective view with a first part of the housing removed;

FIG. 3 is a second perspective view of the embodiment of FIG. 1 with a second part of the housing removed

FIG. 4 is a close-up view of a portion of FIG. 3;

FIG. 5 is a dispensing side view of the embodiment of FIG. 1 with a nozzle removed;

FIG. 6 is a second perspective view of the embodiment of FIG. 1 with the nozzle removed;

FIG. 7 shows details of an additive container of the embodiment of FIG. 1 prior to use;

FIG. 8 shows the additive container of FIG. 7 being prepared for use;

FIG. 9 shows details of the additive container of FIGS. 7 and 8 being connected for use;

FIG. 10 shows details of an alternative embodiment of a beverage dispense fount according to the present invention;

FIG. 11 shows details of a further alternative embodiment of a beverage dispense fount according to the present invention;

FIG. 12 is a cross-section through a portion of the embodiment of FIG. 11;

FIG. 13 shows details of the embodiment of FIG. 1; and

FIG. 14 also shows details of the embodiment of FIG. 1.

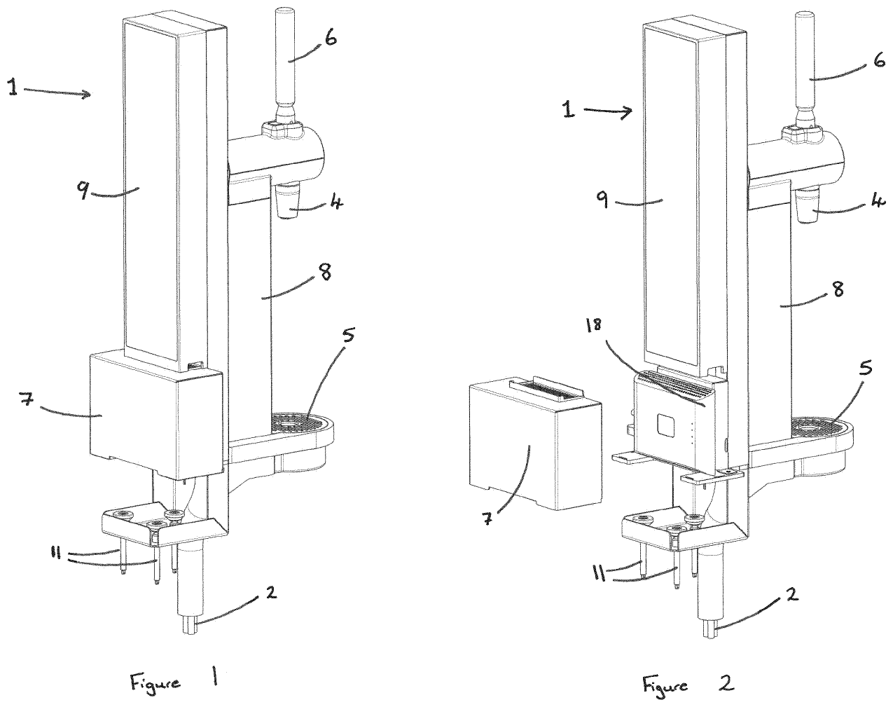

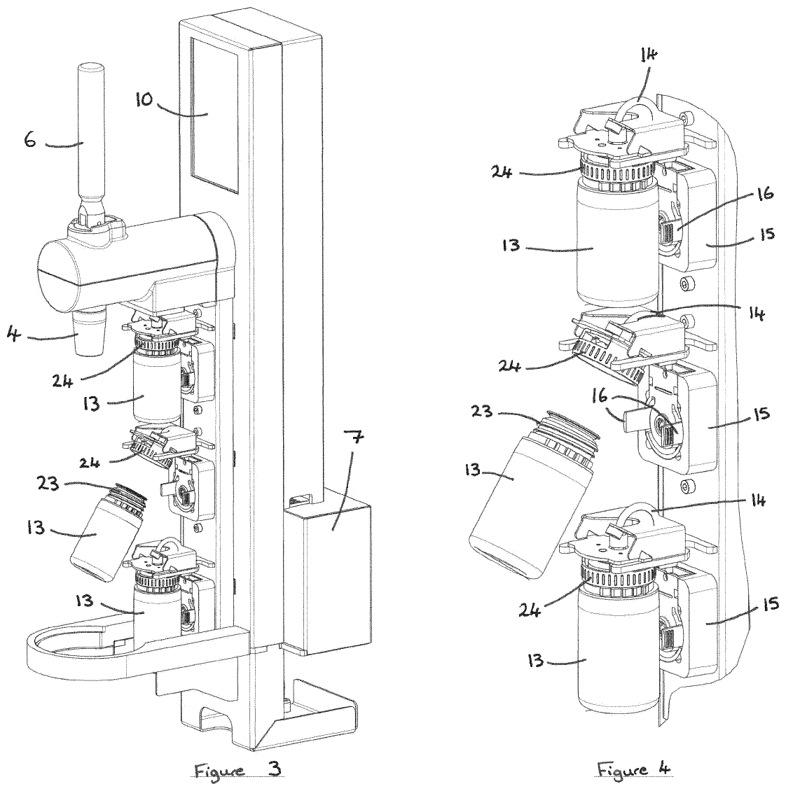

An embodiment of a beverage dispense fount 1 according to the present invention is shown in the FIGS. 1 to 6. The embodiment of the Figures is simply an example and is not to be considered limiting on the scope of the application. Unless indicated otherwise by context or the claims, each feature of the embodiment shown in the Figures may be used in any other embodiment of the invention in isolation from any other feature.

The dispense fount 1 is formed to be mounted on a bar, as might be typically found in many hospitality venues, such as pubs, bars, and restaurants. The dispense fount 1 has a beverage inlet 2 which can be connected to a beverage supply via a suitable supply tube. A beverage outlet 3 is contained within a nozzle 4 through which beverage can be dispensed. The nozzle 4 is mounted immediately above a drip tray 5 on which a glass or other beverage container (not shown) can be positioned when a beverage is being dispensed. A dispensing lever 6 is positioned above the nozzle 4 and can be manually operated to dispense a beverage. Internal components of the dispense fount 1 are formed within a housing having a removable front part 7, and a removable rear part 8. A LCD video screen 9 is formed on a front (customer facing) side of the dispense fount 1 above the removable front part 7. A LCD touch screen 10 is formed on a rear (server facing) side of the dispense fount 1 at an upper end. Clamps 11 are provided for removably mounting the dispense fount 1 to a bar top. A control module (not shown) is mounted within the housing immediately behind the LCD video screen. A presence sensor 12 is mounted within the housing, inside the removable front part 7 of the housing. A cellular router 18 is mounted within the housing, immediately behind the presence sensor 12, and also inside the removable front part of the housing. The presence sensor 12, cellular router 18 and control module are in communication with one another.

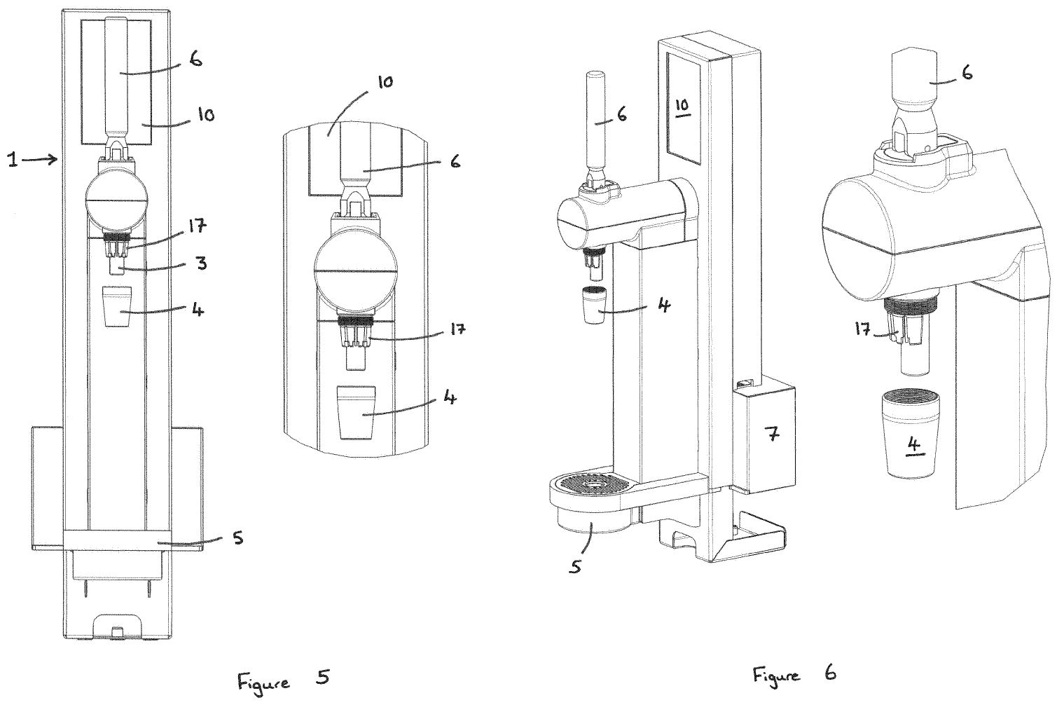

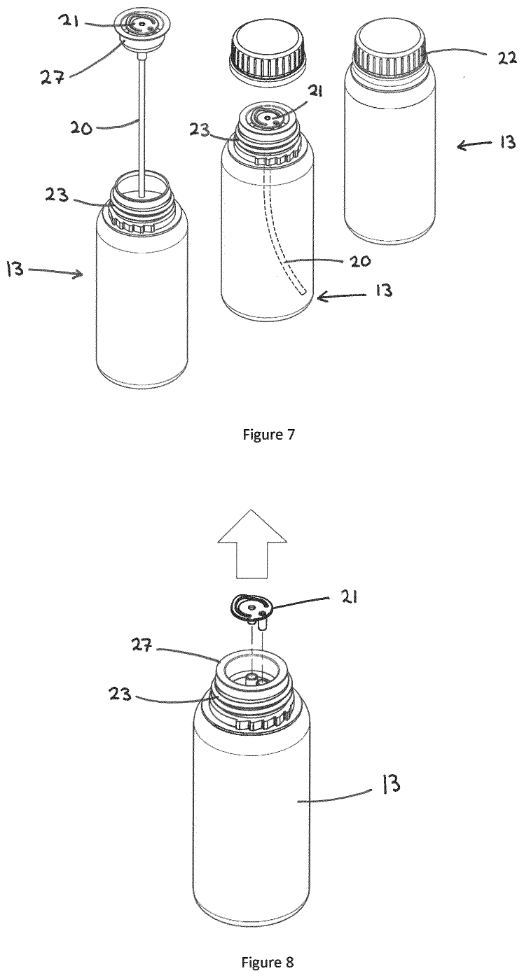

Three additive containers 13 are removably mounted within the removable rear part 8 of the housing. Each additive container 13 is mountable to a cooperatively formed tilting connector by means of a threaded connection comprising a threaded upper portion 23 to the additive container and a connecting cap 24, forming part of the tilting connector, which are discussed in more detail below in relation to FIGS. 7 to 9. Each connecting cap 24 can be titled between a vertical position, as shown in the uppermost and lowermost additive containers 13 of FIGS. 3 and 4, and a tilted position, as shown in the middle connector 14 of FIGS. 3 and 4. This facilitates insertion and removal of the additive containers 13, as shown in FIGS. 3 and 4 in greater detail and as discussed below. A Luer fitting 25 is formed centrally within the threaded connection to put the additive containers 13 in fluid connection with a dispensing line 14 through which liquid additives from each additive container 13 can be dispensed. Each dispensing line extends through a removably mounted peristaltic pump 15, each formed in accordance with the teaching of GB2535595. The peristaltic pumps 15 are removably mounted by resilient clips 16 extending through the peristaltic pumps 15. Each peristaltic pump 15 can be removed by compressing the resilient clips 16 towards one another and pulling the peristaltic pump 15 away from the dispense fount 1. Each dispensing line 14 extends through a peristaltic pump 15 through a body of the dispense fount 1 to an additive outlet 17 formed adjacent the beverage outlet 3 within the nozzle 4. This can be seen clearly in FIGS. 5 and 6. Each peristaltic pump is powered by a stepper motor (not shown) and is controlled by the control module.

The removable front part of the housing 7 is removable to allow access to the presence sensor 12 and the cellular router 18. This can allow the presence sensor 12 and cellular router 18 to be repaired and replaced as necessary. The control module is generally capable of updating remotely via the cellular router 18 but also includes a USB slot to allow updates via a physical connection.

The presence sensor 12 continuously collects mobile carrier signal information and compares it with customer information from one or more mobile service provider databases. When a mobile signal is matched with the database anonymised analytics information such as customer age range, gender, ethnicity, as well as walk maps and product engagement of customers is collected. This anonymised data is then sent to a remote database via the cellular router 18.

Details of the additive container 13 and its connection with the dispense fount 1 are shown in FIGS. 7 to 9.

As shown in FIG. 7, prior to use the additive containers 13 are filled with liquid additive and then sealed with a bung 27 and a pick-up tube 20 assembly having a removable sealing cap 21. A screw cap 22 is then fitted onto a threaded portion 23 formed at the upper end of the additive container 13, covering the bung 21.

In preparation for use, the screw cap 22 and the sealing cap 22 are removed 21, as shown in FIG. 8.

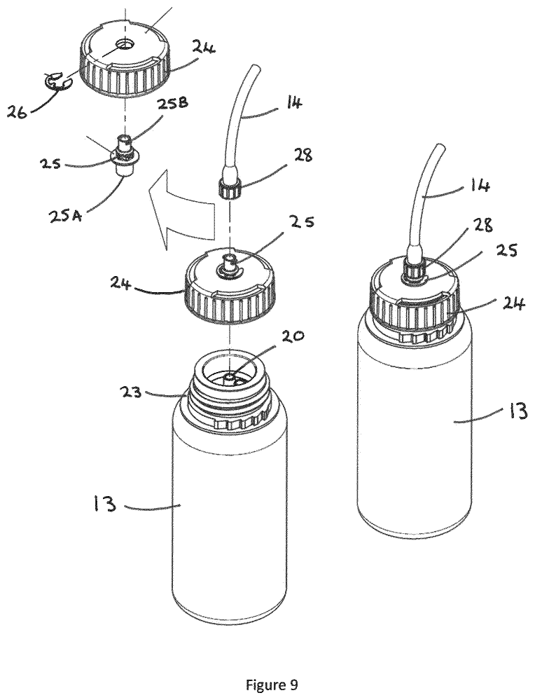

Details of connecting the additive container 13 with the dispense fount 1 are shown in FIG. 9. For clarity, details of a screw fitting 24 of the dispense fount 1 are shown separate from the dispense fount 1. Typically, the screw fitting 24 of the dispense fount 1 remains semi-permanently pivotally mounted in the dispense fount 1 in the manner shown in FIGS. 3 and 4. A luer adapter 25 comprising a male luer 25A in a lower portion and a female luer 25B in an upper position is mounted through a central aperture formed in the screw fitting 24 by means of a resilient clip 26. The luer adapter 25 is connected to the dispensing line 14 via a corresponding luer connector 28 at an outer end. An inner end of the luer adapter 25 protrudes inwardly from a lower face of the screw fitting. The additive container 13 is screwed into position in the screw fitting 24 and the threaded portion 23 engages with a cooperatively formed threaded portion (not shown) formed on an inner side of the screw fitting 24. This pushes the luer adapter 25 into a sealed engagement with an upper end of the bung 27 and pick-up tube 20 assembly such that the dispensing line 14 is in sealed engagement with the additive container 13 and the additive can be dispensed from the additive container under the action of the peristaltic pump 15. When it is necessary to remove the additive container 13 it is simply unscrewed from the screw fitting 24 and removed.

The operation of the dispense fount 1 shown in the Figures is as follows. As an example, the three additive containers 13 of the dispense fount separately contain sugar or other sweetener, a first flavouring, and a second flavouring. The beverage dispensed from the dispense fount 1 is beer.

When a customer approaches the dispense fount 1 if they have a mobile device it will be detected by the presence sensor 12 this will collect publicly available data from the mobile device including, but not limited to, age range, gender & product engagement. This data may be used by the control module to show a personalised video on the LCD video screen 9 facing the customer. The customer may then order a beverage to be dispensed including one or more of the additives available from the additive containers 13.

A person operating the dispense fount will then utilise the LCD touch screen 10 to select the appropriate beverage and will then position a glass beneath the nozzle 4 and pull the lever 6 to dispense the beverage. When the lever 6 is pulled the control module will act to dispense appropriate amounts of additives from the additive containers 13 via the dispensing lines 14 alongside the dispensing of the beverage via the beverage outlet 3, thereby providing a mixed beverage. In particular pulling the lever 6 to dispense the beer and a flow sensor (not shown) located in the supply line detects the flow of beer through the dispense fount 1. When the flow sensor detects the flow of beer the control module activates the appropriate stepper motors to operate the appropriate peristaltic pumps 15 to dispense an appropriate volume of additive. The additives are then dispensed from the dispense fount 14 via the dispensing lines 14 out of the nozzle 4 alongside the beer.

When the bartender selects a beverage to be dispensed this information is also stored and sent to a remote database via a server. The cellular router 18 communicates this information with the server. The cellular router 18 has the ability to connect to 2G, 3G & 4G®, 5G or any other suitable mobile network, and also collects independent logging data to display signal strength on the touch screen 10. Analytics information; timestamp, flavour, sugar or sweetener, latitude/longitude, and location are all sent to the remote database by the cellular router 18 each time a beverage is dispensed.

An appropriate video may be shown on the LCD video screen 9 during the dispensing of the beverage. In particular, the LCD video screen 9 is controlled to show an appropriate video, depending on the specific additives selected. When a beverage is not being dispensed a loop of video content displaying menu items, deals and other media content is shown on the video screen 9. When a beverage is selected on the touch screen, a video will be shown on the video screen 9. Once the beverage has been dispensed the loop of video will be played on the video screen 9 again.

The control module will store information on the beverage dispensed alongside the data detected from the customer's mobile device (if any). The control module is in communication with the cellular router 18 and communicates the stored information with a remote database and a cloud analytics service that stores and analyses order history; sale locations, beverages and additives dispensed, and beverage and additives volumes. The remote database and the cloud analytics service is utilised to present and analyse statistical information such as most popular flavours, as well as graphs, search engines and maps of locations and any other suitable real-time analytic. New video content can be uploaded to the control module via the cellular router 18.

If and when an additive container 13 is empty or requires replacing with an alternative additive the removable rear part 8 of the housing is removed to expose the additive containers 13. The additive container 13 requiring replacement is then tilted outwards and unscrewed in the manner shown in FIGS. 3 and 4. It can then be replaced with a replacement additive container 13, which is screwed into position and then tilted to be vertical. Finally, the removable rear part 8 of the housing is replaced.

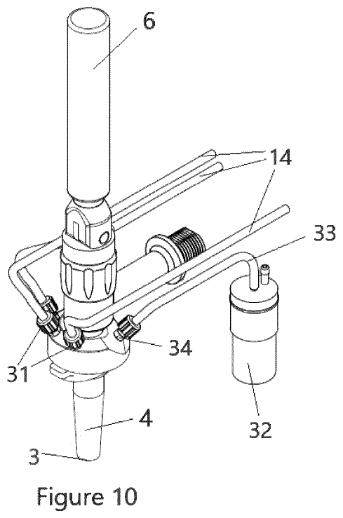

Details of an alternative embodiments of a beverage dispense fount 1 according to the present invention are shown in FIGS. 10 to 12. The alternative embodiments are similar to the embodiment of FIGS. 1 to 6 and only differ in the formation of the beverage outlet 3, the additive outlets 17, the nozzle 4, and additional components directly connected thereto. All other features and components not shown in FIGS. 10 to 12 are identical to the embodiment shown in FIGS. 1 to 6 and are not repeated here. For clarity, where appropriate the same reference numerals have been utilised to indicate the components of the fount shown in FIGS. 1 to 6 have been utilised to indicate the components of the embodiments of FIGS. 10 to 12.

A portion of a first alternative embodiment of a beverage dispense fount 1 according to the present invention is shown in FIG. 10. In this embodiment the dispensing lines 14 join into a beverage supply immediately before the beverage outlet 3 by means of outlet ports 31. The beverage outlet is formed at the end of a nozzle 4. An air pump 32 is provided that is in fluid communication with the nozzle 4 by means of an air tube 33, connected to the beverage supply by means of an air outlet port 34. The dispensing lines 14, outlet ports 31, air pump 32, air tube 33, and air outlet port 34 are all normally contained within the housing of the beverage dispense fount 1, which is omitted from FIGS. 10 to 12 for clarity.

In the embodiment of FIG. 10 when it is desired to dispense a beverage the dispenser will utilise the LCD touch screen 10 to select the appropriate beverage and will then position a glass beneath the nozzle 4 and pull the lever 6 to dispense the beverage. When the lever 6 is pulled the control module will act to dispense appropriate amounts of additives from the additive containers 13 via the dispensing lines 14 alongside the dispensing of the beverage via the beverage outlet 3, thereby providing a mixed beverage. In particular pulling the lever 6 dispense the beer and a flow sensor (not shown) located in the supply line detects the flow of beer through the dispense fount 1. When the flow sensor detects the flow of beer the control module activates the appropriate stepper motors to operate the appropriate peristaltic pumps 15 to dispense an appropriate volume of additive through the dispensing lines 14, into the beverage supply immediately before the beverage outlet 3, through the outlet ports 31. The additives then mix with the beer in the nozzle 4 as the beverage is dispensed. Immediately after a beverage is dispensed the controller will operate the air pump 32 to pulse a blast of air through the air tube 33 into the beverage outlet, via the air outlet port 34, to clear any remaining liquid in the nozzle 4. Thereby ensuring no liquid, either beer or additive, remains in the nozzle 4 after dispensing the beverage.

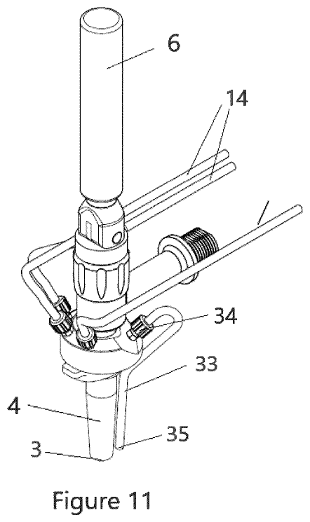

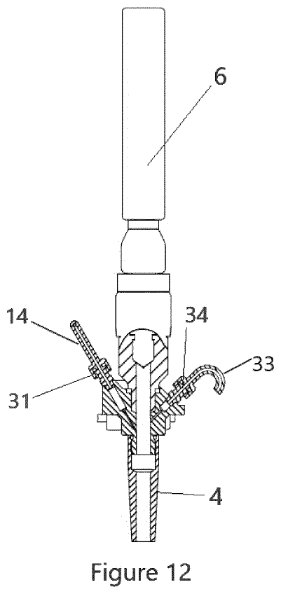

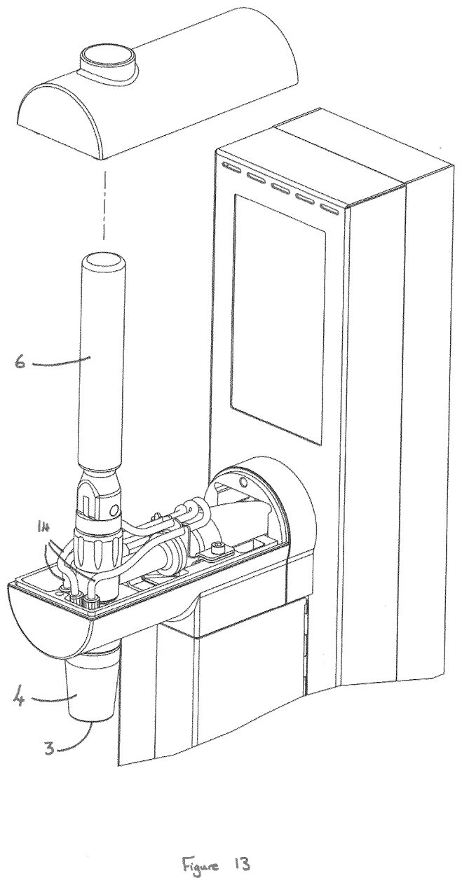

A further alternative embodiment of a beverage dispense fount 1 is shown in FIGS. 11 and 12. This embodiment differs from the embodiment of FIG. 10 in that no air pump is provided and instead the air tube 33 acts as a vent. In particular, the air tube 33 extends generally downwardly from the air outlet port 34 to an open outer end 35 positioned adjacent the nozzle 4. The provision of a vent prevents liquid from being retained in the nozzle 4 under the action of surface tension and ensures that all liquid, including beverage and additive, drains from the nozzle 4 after a beverage is dispensed.

As will be readily understood, FIGS. 10 to 12 are also illustrative of beverage dispense founts 1 according to the second invention of the present application and are understood to be illustrative of that invention.

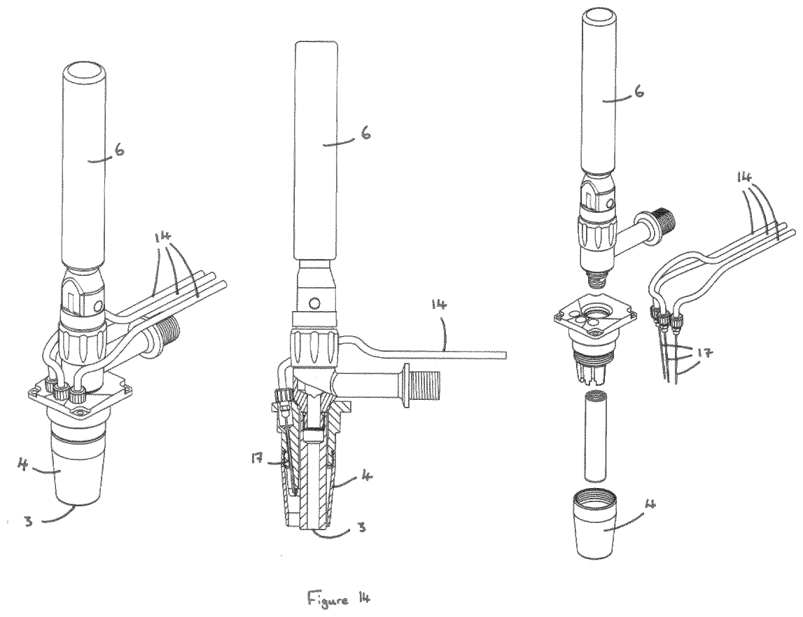

FIGS. 13 and 14 show further details of the embodiment of FIGS. 1 to 6. Full details of the additive outlet of each dispensing line of the embodiment of FIGS. 1 to 6 are shown in FIGS. 13 and 14, and in FIG. 14 in particular. As set out above, each dispensing line 14 extends through a peristaltic pump 15 through a body of the dispense fount 1 to an additive outlet 17 formed adjacent the beverage outlet 3 within the nozzle 4. The additive outlets 17 consist of needle nozzles having an outer end positioned within the removable nozzle 4 and adjacent the beverage outlet 3 such that the additives are dispensed adjacent the beverage and both exit the nozzle 4 together.

The features of the invention shown in the drawings and discussed above are for illustrative purposes only. They are not to be considered on the scope of the application; the invention is defined in the claims. Unless otherwise indicated by context any feature of the invention shown in the drawings and discussed above can be combined with any other feature in accordance with the subject-matter of the invention, as defined in the claims.

1. A beverage dispense fount apparatus comprising:
a beverage inlet connectable to a beverage supply;
a beverage outlet configured to dispense beverage into a beverage container;
a supply line formed between the beverage inlet and the beverage outlet;
at least one additive container, removably mounted within the apparatus and in fluid connection with an additive dispensing line;
a dispensing pump for the or each additive container to dispense additive through the or each additive dispensing lines; and
a controller for controlling dispensing of additives from the fount apparatus.

2. A beverage dispense fount apparatus according to claim 1 comprising:
at least two additive containers, each removably mounted within the apparatus and each in fluid connection with a separate additive dispensing line.

3. A beverage dispense fount apparatus according to claim 1 further comprising an actuating member operable by a user to dispense beverage from the beverage outlet.

4. A beverage dispense fount apparatus according to claim 1, further comprising a dispensing motor associated with the or each additive container for driving the dispensing pumps.

5. A beverage dispense fount apparatus according to claim 1, wherein the or each dispensing pump is a peristaltic pumps.

6. A beverage dispense fount apparatus according to claim 1, having exactly three additive containers.

7. A beverage dispense fount apparatus according to claim 1, further comprising a housing through which the supply line runs and within which the or each additive container and the or each dispensing pump is housed, wherein the housing is openable to allow removal and replacement of the additive containers.

8. A beverage dispense fount apparatus according to claim 1, wherein an opening of the housing is formed on a dispensing side of the apparatus.

9. A beverage dispense fount apparatus according to claim 1, wherein the or each dispensing line is in fluid connection with the supply line.

10. A beverage dispense fount apparatus according to claim 1, wherein the or each dispensing line has an additive outlet positioned adjacent the beverage outlet.

11. A beverage dispense fount apparatus according to claim 10, further comprising a nozzle, wherein the nozzle is mounted around the beverage outlet and the or each additive outlet.

12. A beverage dispense fount apparatus according to claim 1, wherein the or each additive container is removably mounted by means of a threaded connection.

13. A beverage dispense fount apparatus according to claim 12, wherein a threaded connector is formed at an upper end of each additive container.

14. A beverage dispense fount apparatus according to claim 1, further comprising a flow sensor located in the supply line to detect dispensing of a beverage through the supply line.

15. A beverage dispense fount apparatus according to claim 1, further comprising a video screen on a customer facing side of the apparatus.

16. A beverage dispense fount apparatus according to claim 15, wherein when a beverage is dispensed the controller acts to show a video on the video screen, the video being selected on the basis of the beverage and additives being dispensed.

17. A beverage dispense fount apparatus according to claim 1, further comprising a touch screen on a dispensing side of the apparatus for selecting the beverage and additives to be dispensed.

18. A beverage dispense fount apparatus according to claim 1, further comprising a data collection means for storing information on the beverage and additives dispensed from the apparatus.

19. A beverage dispense fount apparatus according to claim 18, further comprising communication means for sharing stored information.

20. A beverage dispense fount apparatus according to claim 18, further comprising presence sensing means for detecting information relating to a customer ordering a beverage.

21. A beverage dispense fount apparatus according to claim 20, wherein the presence sensing means comprises an image sensor for detecting information relating to the customer.

22. A beverage dispense fount apparatus according to claim 20, wherein the presence sensing means comprises means for detecting a customer's mobile device and collecting demographic information therefrom.

23. A beverage dispense fount apparatus according to claim 1, wherein the or each additive dispensing line is in fluid connection with the supply line immediately prior to the beverage outlet by means of an outlet port

24. A beverage dispense fount apparatus according to claim 23, further comprising an air pump that is in fluid communication with the supply line immediately prior to the beverage outlet by means of an air outlet port.

25. A beverage dispense fount apparatus according to claim 23, further comprising an air vent provided in the supply line immediately prior to the beverage outlet.

26. A beverage dispense fount apparatus according to claim 25, wherein an outlet of the vent is positioned adjacent the beverage outlet.

27. A beverage dispense fount apparatus according to claim 26, further comprising a vent tubing extending from the supply line to an open outer end adjacent the beverage outlet wherein the vent tubing extends generally downwardly.

28. A beverage dispense fount apparatus comprising:
a beverage outlet configured to dispense beverage into a beverage container;
a supply line connected with the beverage outlet;
at least one additive dispensing line in fluid connection with the supply line immediately prior to the beverage outlet by means of an additive outlet port; and
an air outlet port formed in the supply line immediately prior to the beverage outlet.

29. A beverage dispense fount apparatus according to claim 28, further comprising:
an air pump in fluid connection with the air outlet port via an air supply line.

30. A beverage dispense fount apparatus according to claim 28, further comprising:
air vent tubing that is attached at an inner end to the air outlet port and is open at an outer end.

31. A beverage dispense fount apparatus according to claim 30, wherein the outer end of the air vent tubing is positioned adjacent the beverage outlet.

32. A beverage dispense fount apparatus according to claim 31, wherein the air vent tubing extends from the supply line to the open outer end positioned adjacent the beverage outlet wherein the vent tubing extends generally downwardly.
